(19) United States
(12) Patent Application Publication
(10) Pub. No.: US 2019/0091498 A1
(43) Pub. Date: Mar. 28, 2019

(54) FILTERED CONTAINMENT ENCLOSURE WITH OVERPRESSURE PROTECTION

(71) Applicant: Deep Three, Inc., Harlan, IN (US)

(72) Inventors: Lee M. Hershberger, Spencerville, IN (US); Steven K. Felton, Fort Wayne, IN (US)

(21) Appl. No.: 16/139,849

(22) Filed: Sep. 24, 2018

Related U.S. Application Data
(60) Provisional application No. 62/562,450, filed on Sep. 24, 2017.

(51) Int. Cl. A62C 2/06; A62C 8/00; B65D 77/06

(52) U.S. Cl. CPC A62C 2/065; B65D 2213/00; B65D 77/067; A62C 8/00

(57) ABSTRACT

A containment enclosure is shown and described. The enclosure is suitable for enclosing an offgas producing object such as an electronic device undergoing a thermal excursion, or a fire containment bag in which such an offgas producing object is contained. The containment enclosure includes an overpressure protection device and internal and external filters to prevent the enclosure from overpressuring while at the same time minimizing the emission of toxins or contaminants to the atmosphere.

### CROSS-REFERENCE TO RELATED APPLICATIONS

This application claims the benefit of U.S. Provisional Patent Application No. 62/562,450, filed Sep. 24, 2017, the entirety of which is hereby incorporated by reference.

### FIELD

The disclosure relates to a containment enclosure for an offgas producing object such as an electronic device undergoing a thermal excursion, or a fire containment enclosure within which an electronic device is undergoing a thermal excursion. More specifically, the disclosure relates to a containment enclosure with overpressure protection and which is configured to reduce the emission of toxic or otherwise harmful constituents of the offgas.

### DESCRIPTION OF THE RELATED ART

Portable electronic devices are ubiquitous. It is common for people to carry smart phones, laptops, and tablet computers from place to place every day. Such devices are often powered by batteries, such as lithium ion batteries, which may experience thermal events (melt down vents, fires, etc.) that can cause large temperature excursions, resulting in temperatures well over 1000° F. If such thermal events occur in crowded and confined areas such as trains, planes, restaurants, buses, etc., containing and isolating the battery is critical to protect others who are nearby. There have literally been hundreds of such events recorded by the FAA in recent years, and the incident frequency continues to increase.

Fire containment bags have been developed for this purpose. Fire containment bags thermally isolate devices undergoing a thermal excursion from the surrounding area. The bags are constructed of one or more layers of fire resistant materials and can withstand high temperatures and high heat loads. However, during a thermal event, electronic devices can produce offgases which are toxic or otherwise harmful. Known fire containment bags cannot retain such offgases without running the risk of rupturing and/or releasing the offgases to the atmosphere, which is problematic because of their toxicity and propensity to contaminate the air with smoke and particulates. For example, during a lithium ion battery melt down event, offgases may include heavy metals, and the simultaneous failure of multiple lithium battery cells may generate smoke.

Thus, a need has arisen for a containment enclosure which addresses the foregoing issues.

### BRIEF DESCRIPTION OF THE DRAWINGS

The disclosure will now be described, by way of example, with reference to the accompanying drawings, in which:

FIG. 1 is a perspective view of a containment enclosure for an electronic device;

FIG. 2 is a close-up, cross-sectional view of a portion of the containment enclosure of FIG. 1; and

FIG. 3 is a close-up perspective view of the containment enclosure of FIG. 1 with half of the enclosure body removed.

### DETAILED DESCRIPTION

The Figures illustrate examples of a containment enclosure for use in containing electronic devices during a thermal excursion. The containment enclosure is preferably used to enclose objects that may produce an offgas with harmful components that should not be released in the atmosphere. In certain examples, the containment enclosure may contain small batteries (such as lithium ion batteries) undergoing a thermal excursion. In other examples, the containment enclosures of the present disclosure act as secondary containment enclosures that enclose a primary containment enclosure, such as a fire containment bag, which contains the electronic device undergoing a thermal excursion. In such cases, the primary containment enclosure absorbs the bulk of heat load caused by the temperature excursion.

In accordance with a first aspect, a containment enclosure is provided which comprises an enclosure body having an interior space, wherein the enclosure body is selectively openable to insert an object capable of producing an offgas. The containment enclosure also includes a relief valve attached to the enclosure body, wherein the relief valve releases gas from the interior of the enclosure body when a pressure in the interior of the enclosure body reaches a threshold pressure. In accordance with certain examples, the containment enclosure also includes an external filter, such as a mesh filter, a carbon filter, or a high-efficiency particulate air (HEPA) filter. In the same or other examples, the containment enclosure also includes an interior filter, such as a mesh filter, in the interior of the enclosure body for capturing particulate matter.

In accordance with a second aspect of the present disclosure, a fire containment system is provided. The fire containment system comprises a selectively openable and closeable fire containment enclosure comprising a one or more layers of fire resistant materials and the containment enclosure of the first aspect, which acts as a secondary containment enclosure.

In accordance with a third aspect of the present disclosure, a method of containing an electronic device having a thermal excursion is provided. The method comprises providing the fire containment system of the second aspect, inserting the electronic device into the selectively openable and closeable fire containment enclosure, and inserting the selectively openable and closeable fire containment enclosure into the secondary containment enclosure. In certain examples, the pressure in the interior of the containment enclosure reaches or exceeds a threshold pressure, causing gas to flow out of the containment enclosure relief valve.

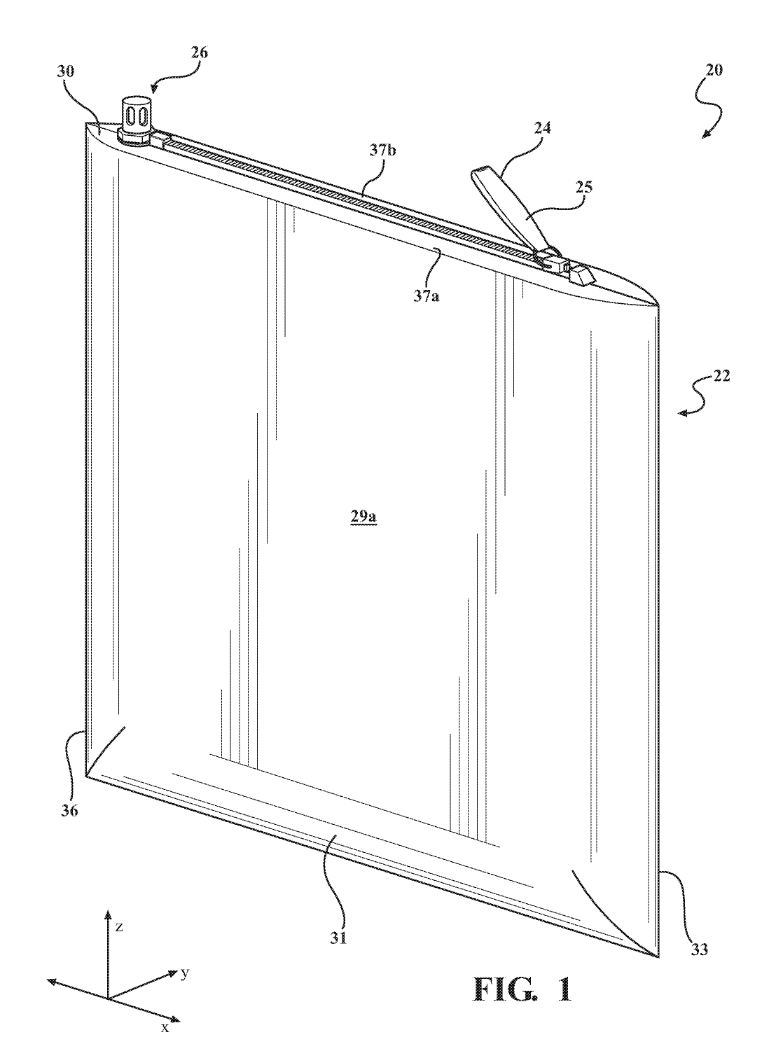

Referring to FIG. 1, containment enclosure 20 is depicted. Although a variety of shapes and sizes may be provided, the depicted example is that of a zippered pouch. Containment enclosure 20 is configured to hold an offgas producing object and reduce the level of contaminants in the offgas before releasing it to the atmosphere. In preferred examples, containment enclosure 20 also includes an overpressure protection mechanism to prevent the enclosure 20 from rupturing.

Containment enclosure 20 may act as a primary containment enclosure in which an electronic device undergoing a thermal excursion is inserted. Containment enclosure 20 may also acts as a secondary containment enclosure and be provided as part of a fire containment system that also comprises a fire containment enclosure. A fire containment enclosure comprises at least two panels or sidewalls formed from one or more layers of fire resistant materials and is sealable at the top. Suitable fire resistant materials include cotton, fiberglass, carbon felt, and KEVLAR® (aramid fibers supplied by the DuPont Company). The fire containment enclosure is selectively openable and closeable and may include, for example, a zipper, a hinged lid with fire resistant VELCRO® fasteners (i.e., hook and loop fasteners on the lid and the body of the containment enclosure) or a hinged lid with a zipper. The purpose of the fire containment enclosure is to absorb the thermal load of an electronic device experiencing a thermal excursion and to thermally isolate the electronic device from the surrounding area.

The materials of construction of many known fire containment bags do not readily lend themselves to providing overpressure protection or filters for filtering any offgases that may be released from the fire containment enclosure. Thus, containment enclosure 20 is designed to reduce the contaminants (toxins, particulates, smoke) in the offgas before releasing the offgas to the atmosphere. The containment enclosure 20 preferably contains the offgas until the pressure within the enclosure 20 reaches or exceeds a predetermined threshold and then releases the offgas after filtering it.

Thus, during an electronic device thermal excursion, the fire containment enclosure (with the electronic device in it) is inserted into containment enclosure 20 (or, depending on the device, it may be inserted directly into containment enclosure 20). Containment enclosure 20 is generally in the shape of a pouch and includes a body 22, a first side 29a, a second side 29b (not shown), and an extension flange 30. Extension flange 30 defines the top (exposed) surface of the containment enclosure 20. First side 29a and second side 29b are attached at seams 31, 33 and 36.

The overpressure protection mechanism depicted in the examples is a relief valve assembly 26 which is configured to prevent the containment enclosure 20 from overpressuring by filtering and releasing gas contained in its interior 27. Containment enclosure 20 also includes a zipper assembly 24 on a top surface of the enclosure 20 proximate relief valve assembly 26. The relief valve assembly 26 is configured to release gas from the interior 27 of the containment enclosure 20.

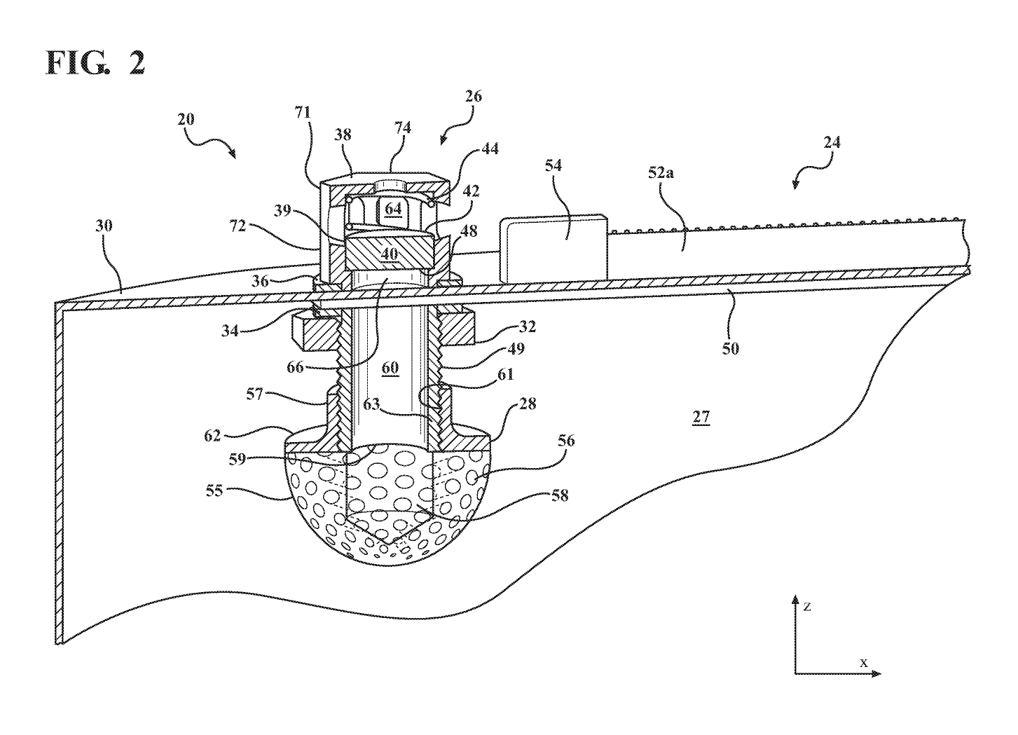

The relief valve assembly 26 is best seen in FIG. 2. In the depicted example, relief valve assembly 26 includes an internal filter 28 and an external filter 40. The internal filter 28 is configured to remove relatively large particles relative to the external filter 40. Thus, the internal filter acts as a “coarse” filter, and the external filter acts as a “fine” filter in terms of the particle diameters they are designed to capture. Depending on the nature of the gas within the containment enclosure 20, one of the filters 28, 40 may be eliminated.

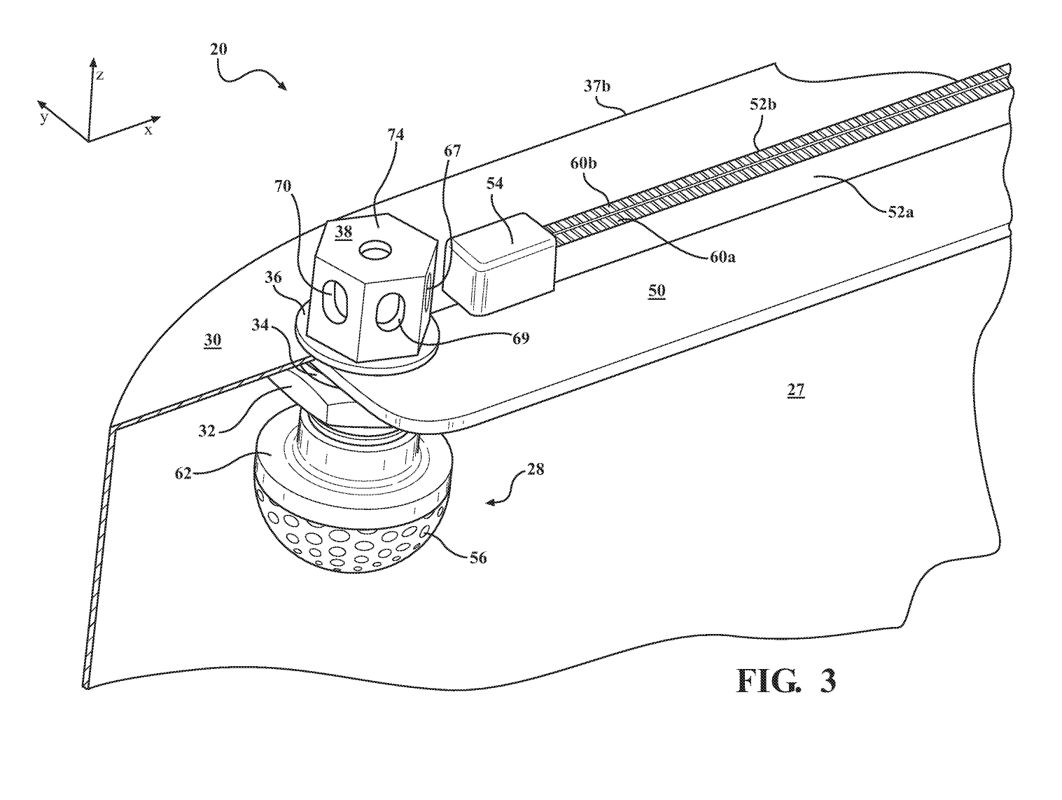

The assembly 26 includes a valve body defined by external filter medium 40 and a housing (not separately shown except for a top portion 42) that houses filter medium 40. Venting cap 38 has the shape of a hexagonal prism (FIG. 3) and includes a plurality of vents 64, 65, 67, 69, 70, 73 (each hexagonal face includes a vent opening, but only vent openings 64 and 65 are shown). When the pressure in the interior 27 of the containment enclosure 20 exceeds a threshold pressure, the relief valve assembly 26 will release gas from within the interior 27 through vents 64, 65, 67, 69, 71, and 73. Exemplary threshold pressures range from about 2 psig to about 5 psig, preferably from about 2.5 psig to about 4.5 psig, and more preferably from about 3 psig to about 4 psig.

Referring to FIG. 2, valve body 39 is movable along the vertical (z) axis depending on the forces exerted in the downward (z) direction by biasing spring 44 and in the upward direction by gas pressure in interior 27 of containment enclosure 20. When the pressure in the interior 27 is less than a threshold pressure (dictated by the spring constant and the area of the valve body 39 against which the spring 44 acts), valve body 39 will remain seated against valve seat 48 (which is the top annular surface of the distal end of bulkhead nipple 49). In this position, there is no radially outward path for gas to flow from filter media 40. However, when the interior 27 pressure exceeds the threshold pressure, the valve body will move upward along the vertical (z) axis, expanding z-axis gap 66 between the valve body 39 and the extension flange 30. Filter media 40 is annularly shaped. Gas enters through an axial (z-axis) opening in the center of the filter media 40 and then flows outward radially (in a direction substantially parallel to the x-y plane). When filter media 40 is seated on valve seat 48, the gas exit path through vent openings 64, 65, 67, 69, 71, and 73 is blocked by lower portion 72 of venting cap 38. However, once the filter media 40 reaches vertical (z-axis) position of the vent openings 64, 65, 67, 69, 71, and 73, gas can flow into filter media 40, and out of vents 64, 65, 67, 69, 71, and 73.

As mentioned previously, valve body 39 includes a valve housing (only the upper surface 42 is visible in FIG. 2) in which a filter media 40 is contained. The upper surface of the valve housing 42 blocks gas from flowing axially through filter media 40. Filter media 40 is, in certain preferred examples, a high-efficiency air (HEPA) filter or a mesh filter. Multiple filter layers may also be used and arranged concentrically. In one example, a carbon fiber filter is used with a HEPA filter, and the gas flows through the center of the filter structure and exits radially outward through both layers.

As the valve body 39 moves upward (z-axis), it will eventually reach a point where the filter media 40 is in fluid communication with vents 64, 65, 67, 69, 71, and 73. In preferred examples, valve housing 42 has a cylindrical shape and open areas around its circumference to allow gas to travel radially out through housing 42 and vents 64, 65, 67, 69, 71, and 73. Thus, when filter media 40 is located at the same vertical (z) axis height as the vents 64, 65, 67, 69, 71, and 73, the interior 27 of the enclosure 20 is in fluid communication with the vents 64, 65, 67, 69, 71, and 73.

Internal filter 28 is provided in interior 27 of containment enclosure 20. Internal filter 28 is preferably a mesh filter configured to capture large (relative to external filter 42) particulate matter and comprises mesh section 55 and neck section 57. Upper seal 62 prevents any gas from flowing back into the interior 27. Instead, gas flowing through mesh elements 56 enters a central opening 60 within a bulkhead nipple 49. Bulkhead nipple 49 has a first end that defines proximal opening 59 which is connected to mesh filter 28. As mentioned previously, bulkhead nipple 49 has a distal end that defines a distal opening, and the surface of the bulkhead nipple 49 at the distal end acts as a valve seat 48. External threads 63 on bulkhead nipple 49 threadingly engage corresponding internal threads 61 on internal filter 28 to secure the bulkhead nipple 49 to the internal filter 28. Thus, proximal opening 59 of bulkhead nipple 49 is located within the internal filter 28 to place the central opening 60 of bulkhead nipple in fluid communication with internal filter conduit 58. Mesh section 55 includes individual mesh elements 56. In certain examples, the individual mesh elements 56 have a mesh size (i.e., number of mesh openings per linear inch) from about 50 to about 300 mesh, preferably from about 75 to about 250 mesh, and more preferably from about 100 to about 200 mesh.

In certain applications, containment enclosure 20 may contain offgases with magnetic particles. In such cases, it may be advantageous to exploit the magnetic properties of such particles by adding a magnet to relief valve assembly 26 to capture the particles. Lithium ion batteries generate smoke containing cobalt, nickel, and copper, the first two of which are magnetic. In one example, a neodymium (Nd) magnet is used. With respect to the flow path of offgas out of relief valve assembly 26, the magnet is preferably placed upstream (ahead of) the external filter medium 40 to reduce the captured particle loading of external filter medium. In the same or other examples, the magnet is preferably placed downstream (after) the internal filter 28 so that larger particles that may be unable to enter internal filter 28 are not captured by the magnet, which thereby reduces the captured particle loading of the magnet. In one example, the magnet is placed on the inside of internal filter 28 near the lowest point of the internal filter (i.e., the lowest z-axis position when the enclosure 20 is oriented as shown in FIG. 1). The magnet is preferably sized (in x-y) to attract and capture as many heavy metal particles as possible without unduly restricting the flow of offgas through the internal filter 28.

Bulkhead nipple 49 extends through an opening in the upper surface (i.e., through an opening in the extension flange 30). Bulkhead nipple 49 also extends through zipper flange 50 (described below), which is bonded to the extension flange 30.

Venting cap 38 is connected to bulkhead nipple 49 on the exterior of the containment enclosure 20. Venting cap 38 includes a top section 71 and a bottom section 72. Top section 71 includes a top 74 and a plurality of vents 64, 65, 67, 69, 70, and 73 which are arranged circumferentially around venting cap 38. Bottom section 72 is annular in shape and receives an upper end of bulkhead nipple 49. The venting cap bottom section 72 is fixedly secured to the upper end of bulkhead nipple 49, such as by threaded engagement. A locking nut 32 threadingly engages the outer surface of bulkhead nipple 49 within the interior 27 of containment enclosure 20. First sealing washer 34 is located between the locking nut 32 and the zipper flange 50. Second sealing washer 35 is located between an exterior circumferential surface of venting cap 38 bottom section 72 and extension flange 30. As locking nut 32 is tightened, it moves vertically along the z-axis and squeezes the extension flange 30 and zipper flange 50 to hold the relief valve assembly 26 in place.

Zipper assembly 24 provides a means for selectively providing access to the interior 27 of the containment enclosure 20. Zipper assembly 24 includes a zipper flange 50 (half of which is visible in FIG. 3). Zipper assembly 24 also comprises first and second rails 52a and 52b each having corresponding teeth 60a and 60b. Puller 25 (FIG. 1) is provided and is manipulable by a user to engage and disengage teeth 60a and 60b to selectively access the interior 27 of the containment enclosure 20.

Containment enclosure 20 is preferably air tight. Different tests for airtightness may be used. In one test of airtightness, the enclosure 20 is filled with a gas and connected to a pressure gauge (a fitting would be required to do this). If the gauge pressure decreases by a specified amount (e.g., 0.5 psig over 1 day), the enclosure 20 would be deemed to be not airtight. Another test would be to fill enclosure 20 with a gas and measure a width of the enclosure 20 and/or the weight of the enclosure at the time of filing and at some time later. A specified change over a specified period of time would indicate that the enclosure 20 is not airtight. The enclosure 20 is also preferably water tight and similar tests could be used to determine water tightness.

The materials used to form the enclosure body 22 (comprising sides 29a, 29b, and extension flange 30) are preferably polymers or polymer composite which act as a vapor barrier and have good vapor chemical resistance. In one example, aluminized fiberglass may be used to form enclosure body 22. One suitable type of aluminized fiberglass material is the Z-Flex Multilayer Aluminized (MLA) family of fabrics supplied by Newtex Industries, Inc. of Victor, N.Y. One exemplary member of this family which may be used is the Z-Flex-A801, a Zetex® highly texturized fiberglass fabric that offers superior insulation to protect from extreme heat and sunburn.

The Newtex Z-Block fire and smoke resistant materials are also suitable for use in forming enclosure body 22. Z-Block flame resistant fabrics are high temperature polymer coated fiberglass fabrics treated with a proprietary formulation of fire retardants. The Z-Block fabrics include texturized fiberglass, filament fiberglass, and wire-reinforced fiberglass, with fire resistant coatings, including formulations of vermiculite, acrylic, and polyurethane.

One preferred example of the Z-Block fabrics is Z-Block F-407 (Part No. 1100268), which has a filament glass base fabric, a 4H Satin weave structure, and a Z-Block FS finish/coating. Z-Block F-407 is a fire and smoke resistant fabric that is also weather and water resistant and which supports peak temperatures of up to 1800° F. The Z-Block materials are also optionally supplied with a silicone overcoat (SOC) and/or wire reinforcement, either of which may be used.

Zipper assembly 24 is also preferably airtight and water tight. In one example, the rails 52a and 52b, stop 54 and zipper flange 50 are all formed from a rubber. Exemplary rubbers include synthetic rubbers with good chemical and thermal resistance such as chlorinated sulfonated polyethylene (CSPE), which was formerly supplied by the DuPont Company under the name Hypalon®. Teeth 60a and 60b preferably comprise a metal such as brass. Zipper flange 50 has an opening between rails 52a and 52b to provide access to interior 27 of containment enclosure 20. In one example, the stop 54, rails 52a and 52b and zipper flange 50 are all integrally molded as a single piece. Integrally molding the zipper assembly 24 facilitates providing airtightness by avoiding leak points between the rails 52a and 52b and the zipper flange 50 which would be more likely if the rails 52a and 52b were separately formed and then attached to the zipper flange 50.

As mentioned previously, the containment enclosure 20 may be used as a secondary containment enclosure with a fire containment enclosure. Exemplary fire containment enclosures include the “Battery Explosion & Fire Containment Bag” (SKU FP-CON-LG) supplied by the Brimstone Fire Protection of Spencerville, Ind., and the Firesock, supplied by Aircare International, Inc. of Stateline Nevada.

For example, in a secondary containment application, if a lithium ion battery were to catch fire, it would first be inserted in a fire containment enclosure, and the lid would be closed. If hook and loop fasteners are provided, the lid would be secured to the body of the fire containment enclosure by contacting the hook fasteners on one of the body and the lid with loop fasteners on the other of the body and the lid. If a zipper were used instead, it would be zipped closed. The fire containment enclosure would then be inserted into the containment enclosure 20, and the puller 25 (FIG. 1) would be pulled away from stop 54 until reaching a stop at the other end (not shown) to fully close the enclosure 20. If the fire containment enclosure produces smoke and gas, the pressure in the interior 27 of the containment enclosure may exceed the threshold pressure. At that point, the valve body 39 (FIG. 3) will disengage from valve seat 48 and begin moving upward along the z-axis against the force of biasing spring 44 until reaching a stopping position at which spring 44 is fully compressed. At that point, the filter media 40 will be in fluid communication with the vents 64, 65, 67, 69, 71, and 73. Gas will flow to the center of filter media 40 and will flow in a radially outward direction through the vents 64, 65, 67, 69, 70, and 73. The filter media 40 will remove some of the smoke, particulates, heavy metals, and/or other air contaminants. Once the thermal excursion ceases, the pressure in the interior 27 of the containment enclosure 20 will drop below the threshold pressure, causing the valve body 39 to reseat.

A method of making the containment enclosure 20 will now be described. In accordance with the method, a generally rectangular sheet of the materials used to form body 22 is provided and includes the sections used to form sides 29a and 29b. Zipper assembly 24 is provided as an integrally molded unit. A rectangular opening is cut in the middle of the generally rectangular sheet, and it is turned over so that the zipper flange 50 can be bonded to the underside of the sheet. The sheet is then turned over. Extension flange 30 is provided as a rectangular strip with a rectangular opening that can accommodate the rails 52a, 52b, stop 54, and puller 25. Extension flange 30 is placed over the rails 52a, 52b, stop 54, and puller 25 and is bonded to the flat sheet to define seams 37a and 37b.

Bulkhead nipple 49 is inserted through openings in zipper flange 50 and extension flange 30. Washer 34 is positioned adjacent the zipper flange 50, and locking nut 32 is screwed onto the bulkhead nipple 49. Washer 36 is positioned on the distal end of bulkhead nipple and positioned adjacent exterior flange 30. Venting cap 38 with spring 44 and filter media 40 (as well as its housing) installed is attached to the distal end of the bulkhead nipple 49 and screwed into place. Locking nut 49 is adjusted to fix the relief valve assembly 26 in place.

The sides 29a and 29b are bonded to create seams 31, 33 and 36. The bonds are preferably sufficient to make the containment enclosure 29 airtight and watertight. In certain examples, a sealing strip (or strips) may be used to join the sidewall layers 29a and 29b to each other and the zipper flange 50.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their r equivalents, rather than by the preceding description.

What is claimed is:

1. A containment enclosure, comprising:
an enclosure body having an interior space, wherein the enclosure body is selectively openable to insert an object capable of producing an offgas;
a relief valve attached to the enclosure body, wherein the relief valve releases gas from the interior of the enclosure body when a pressure in the interior of the enclosure body reaches a threshold pressure.

2. The containment enclosure of claim 1, wherein the relief valve comprises vents external to the enclosure body and a valve body that is selectively movable to place the vents in fluid communication with the interior of the enclosure body.

3. The containment enclosure of claim 1, further comprising an external filter that is in selective fluid communication with the interior of the enclosure body.

4. The containment enclosure of claim 3, wherein the external filter is at least selected from a high efficiency particulate air (HEPA) filter, a mesh filter, or a carbon fiber filter.

5. The containment enclosure of claim 1, wherein the relief valve includes a valve body and a housing with at least one vent external to the enclosure body, the valve body comprises a filter, and the valve body is biased into a position in which the filter is not in fluid communication with the at least one vent external to the enclosure body.

6. The containment enclosure of claim 5, wherein the relief valve further comprises a biasing spring that biases the filter in a direction toward the interior of the enclosure body.

7. The containment enclosure of claim 5, wherein when the pressure in the interior of the enclosure body exceeds the threshold pressure, the valve body moves in a direction toward the at least one vent.

8. The containment enclosure of claim 1, further comprising an internal filter located in the interior of the enclosure body.

9. The containment enclosure of claim 8, wherein the internal filter is a mesh filter.

10. The containment enclosure of claim 9, wherein the mesh filter has a mesh size ranging from about 50 mesh to about 300 mesh.

11. The containment enclosure of claim 1, wherein the relief valve assembly further comprises a magnet positioned to capture magnetic particles in the gas when the pressure in the interior of the enclosure body reaches a threshold pressure.

12. The containment enclosure of claim 11, wherein the magnet is attractive to at least one of cobalt and nickel.

13. The containment enclosure of claim 12, further comprising an internal filter located in the interior of the body, wherein the magnet is located within the internal filter.

14. The containment enclosure of claim 1, wherein the enclosure body comprises two sides and an extension flange, and the relief valve is attached to the extension flange.

15. The containment enclosure of claim 1, further comprising a zipper assembly having a rubber flange and a first and second plurality of metal teeth, wherein the first plurality of metal teeth is selectively engageable and disengageable with the second plurality of metal teeth to selectively close and open the enclosure body.

16. The containment enclosure of preceding claim 1, wherein the enclosure body comprises a polymer coated fiberglass.

17. The containment enclosure of claim 1, wherein the enclosure body comprises an aluminized fiberglass.

18. The containment enclosure of claim 1, wherein when the enclosure is in a closed configuration, the enclosure is airtight.

19. A fire containment system, comprising:
a selectively openable and closeable fire containment enclosure comprising one or more layers of fire resistant materials;
a secondary containment enclosure, comprising the containment enclosure of claim 1.

20. The fire containment system of claim 19, wherein the selectively openable and closeable fire containment enclosure includes a body and a zipper or a hinged lid with one or more fold over flaps.

21. The fire containment system of claim 20, further comprising a zipper or fire resistant hook and loop fasteners for selectively securing the one or more fold over flaps to the containment enclosure body.

22. The fire containment system of claim 19, wherein the fire resistant materials are selected from the group consisting of cotton, fiberglass, carbon felt, and aramid fibers.

23. A method of containing an electronic device having a thermal excursion:
providing the fire containment system of claim 19;
inserting the electronic device into the selectively openable and closeable fire containment enclosure; and
inserting the selectively openable and closeable fire containment enclosure into the secondary containment enclosure.

24. The method of claim 23, wherein following the step of inserting the selectively openable and closeable fire containment enclosure into the secondary containment enclosure, gas leaks from the fire containment enclosure such that the pressure in the enclosure exceeds the threshold pressure, and the gas flows out of the relief valve.
